(19) United States
(12) Patent Application Publication
(10) Pub. No.: US 2010/0313425 A1
(43) Pub. Date: Dec. 16, 2010

(54) VARIABLE AMPLITUDE VIBRATING PERSONAL CARE DEVICE

(76) Inventor: Christopher Martin Hawes, Reading (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/796,032

(22) Filed: Jun. 8, 2010

Related U.S. Application Data
(60) Provisional application No. 61/186,158, filed on Jun. 11, 2009.

(51) Int. Cl. B26B 19/28

(52) U.S. Cl. 30/44

(57) ABSTRACT

Vibrating personal care devices are provided by the present invention. The personal care devices generally employ a head, a handle extending from the head, a vibration-inducing mechanism or system, and means for adjusting the amplitude of the vibration.

### CROSS REFERENCE TO RELATED APPLICATIONS

This application claims the benefit of U.S. Provisional application Ser. No. 61/186,158, filed on Jun. 11, 2009.

### FIELD OF THE INVENTION

The present invention is directed to vibrating personal care devices that have a vibration amplitude adjustment. Such vibrating devices include, for example, razors, toothbrushes, skin care devices, cosmetic devices, and hair care devices. The personal care devices of the present invention may be used for treating oneself and/or for treating others. The devices may also be used for treating pets.

### SUMMARY OF THE INVENTION

Vibrating personal care devices are provided by the present invention. The personal care devices generally employ a head, a handle extending from the head, a vibration-inducing mechanism or system, and means for adjusting the amplitude of the vibration. The head can be designed and configured for a variety of end uses. For example, the head may include a blade or blade cartridge wherein the device is used as a razor. The head may also include one or more bristles or fibers that can interact with hair, skin, and teeth in accordance with personal care regimens. The head can also include a solid surface for engaging soft or hard tissue associated with mammalian (e.g., humans, dogs, and cats) bodies. The head may be designed for separation by the consumer, or alternatively, be designed for permanent attachment to the handle of the device. The head can optionally include replaceable parts wherein the entire head does not need to be discarded for additional treatment with the device. The device head may be a recognizable distinct component affixed to the handle, or may, depending on the design criteria, be simply an extension of the handle or reside at one end of the handle wherein the head and handle have the appearance of a single continuous component.

In accordance with one exemplary embodiment, the handle includes a motor comprising a rotatable shaft; a mass affixed to the shaft, the mass being displaceable in a radially outward direction relative to the shaft in the presence of centrifugal force arising when the shaft is rotated; and a displacement restrictor movable relative to the mass in order to adjust and/or control the amount of radial displacement of the mass.

In accordance with a second exemplary embodiment, the handle includes one or more interior compartments comprising a motor comprising a rotatable shaft; a battery to power the motor; a bob-weight affixed to the rotatable shaft, at least a portion of the bob-weight being constructed from material that can be acted upon by a magnetic field; and a magnet movable relative to the bob-weight to effect radial displacement of the bob-weight.

In accordance with another exemplary embodiment, the handle includes a vibration-inducing system; and a vibration amplitude adjuster comprising a magnet that is movable relative to the vibration-inducing system, wherein the magnet is capable of altering the position of at least one component of the vibration-inducing system so that the vibration amplitude changes.

One of ordinary skill in the art should appreciate that while the vibration-inducing mechanism or system and means for adjusting the amplitude of the vibration of the above-described embodiments are positioned within the handle of the personal care devices, portions or all of these features may also reside in the device head.

Methods of adjusting and/or controlling vibration amplitude associated with personal care devices are also provided by the present invention. In accordance with one exemplary embodiment, the method comprises the steps of (a) providing a personal care device comprising a motor, a rotatable motor shaft, and a mass affixed to the shaft, wherein the mass is radially movable relative to the shaft between a first position when the shaft is not rotating to a second position when the shaft is rotating; and (b) restricting the location of the mass to a third position that is situated between the first position and the second position, thereby adjusting and/or controlling the amplitude of the vibrating device.

In accordance with a second exemplary embodiment, the method comprises the steps of providing (a) a razor comprising a motor, a rotatable motor shaft, and a mass affixed to the shaft, wherein the mass is radially movable relative to the shaft between a first position when the shaft is not rotating to a second position when the shaft is rotating; and (b) moving a magnet proximally or distally with respect to the mass, thereby adjusting and/or controlling the amplitude of the vibrating device.

### BRIEF DESCRIPTION OF THE DRAWINGS

While the specification concludes with claims particularly pointing out and distinctly claiming the subject matter which is regarded as forming the present invention, it is believed that illustrative embodiments of the present invention may be better understood from the following description taken in conjunction with the accompanying drawings, in which:

FIG. 1 is a perspective view of a vibrating razor embodiment provided by the present invention;

FIG. 2 is a perspective view of a portion of the handle associated with the embodiment shown in FIG. 1;

FIGS. 3A-3C are schematics that illustrate movable mass and restrictor features of an amplitude-adjusting system provided by the present invention; and

FIG. 4 is a schematic that shows features of an alternative amplitude-adjusting system provided by the present invention.

### DETAILED DESCRIPTION OF THE INVENTION

The present invention may be understood more readily by reference to the following detailed description of illustrative and preferred embodiments. It is to be understood that the scope of the claims is not limited to the specific components, methods, conditions, devices, or parameters described herein, and that the terminology used herein is not intended to be limiting of the claimed invention. Also, as used in the specification, including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent basis “about,” it will be understood that the particular values form another embodiment. All ranges are inclusive and combinable.

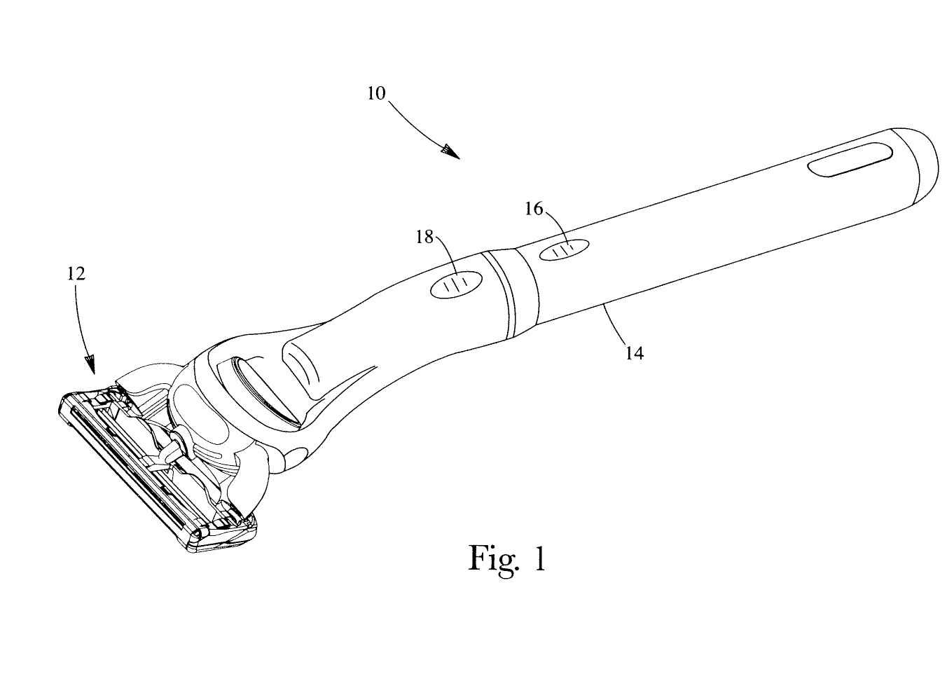

Referring now to the figures and in particular to FIG. 1, an exemplary personal care device 10 is shown in the form of a razor. Device 10 includes head 12 defined at least in part by a blade cartridge, and a handle 14 extending from head 12. Handle 14 is shown with a first actuator 16 that serves as the “on/off” switch for converting device 10 from a static device to a vibrating device. A second actuator 18 is shown which serves as the consumer interface for adjusting the vibration amplitude. Although actuators 16 and 18 are illustrated as two distinct and separate components, a single actuator could be employed to serve both functions; for example, a first depression of the single actuator may activate the vibration-inducing mechanism causing the device to vibrate at a first amplitude, a second depression could change to a second amplitude, and a third depression could turn the vibration off.

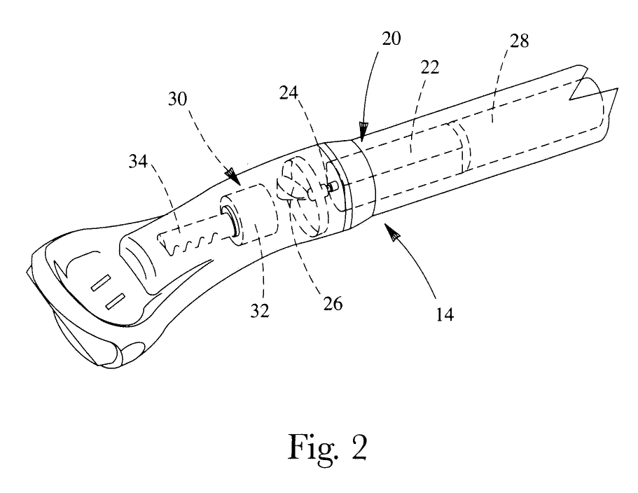

Some internal components and systems of exemplary device 10 are shown in FIG. 2, including an exemplary vibration-inducing system 20 and an exemplary vibration amplitude adjusting system 30. Vibration-inducing system 20 includes a motor 22, a rotatable shaft 24, a mass or bob-weight 26 affixed to shaft 24, and a battery 28. Actuator 16 (shown in FIG. 1) is electrically connected to vibration-inducing system 20. Mass or bob-weight 26 is displaceable in a radially outward direction in the presence of centrifugal force arising when shaft 24 is rotated. It should be noted that although a bob-weight arrangement is shown in the figures herein, alternative movable mass arrangements can equally be employed; for example, a slotted member can be affixed to the rotatable shaft and a movable mass disposed within the slot.

Exemplary vibration amplitude adjusting system 30 comprises a displacement restrictor 32 that is attached to a rack 34 and pinion (not shown) mechanism for moving restrictor 32 relative to mass 26. Rack 34 and/or restrictor 32 is connected to actuator 18 (shown in FIG. 1) to enable a user to move restrictor 32 closer to or farther away from mass 26. When a rack and pinion or similar type of movement mechanism is employed, actuator manipulation consists of distinct positioning of the restrictor relative to the rotating mass. Other movement mechanisms can however be employed wherein actuator manipulation can permit more fluid, continuous positioning of the restrictor relative to the rotating mass.

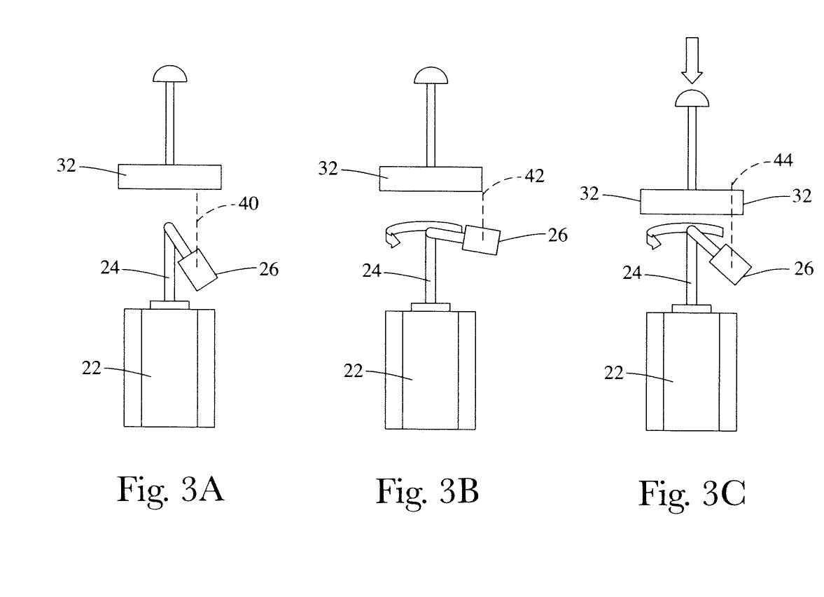

Referring now to FIG. 3A, when the vibration-inducing system is off, bob-weight 26 is located in a first position 40 that is relatively close to shaft 24. When the vibration-inducing system is turned on, via actuator 16 (shown in FIG. 1), shaft 24 rotates causing bob-weight 26 to swing radially outwardly and away from shaft 24 due to the centrifugal force. If unrestricted, bob-weight 26 can swing outwardly to a second position 42, an example of which is shown in FIG. 3B. As illustrated in FIG. 3C, restrictor 32 can be moved towards bob-weight 26 to cause bob-weight 26 to assume an intermediate position 44 that is in between first position 40 and second position 42. The vibration amplitude adjustment through movement of restrictor 32 towards bob-weight 26 can be accomplished, as shown in FIGS. 3A-3C, without physical contact between restrictor 32 and bob-weight 26 through employment of magnets in association with each of restrictor 32 and bob-weight 26. The respective magnets are arranged so that repulsion between the two reacts against the centrifugal force to reposition bob-weight 26 to an intermediate position, such as, for example position 46.

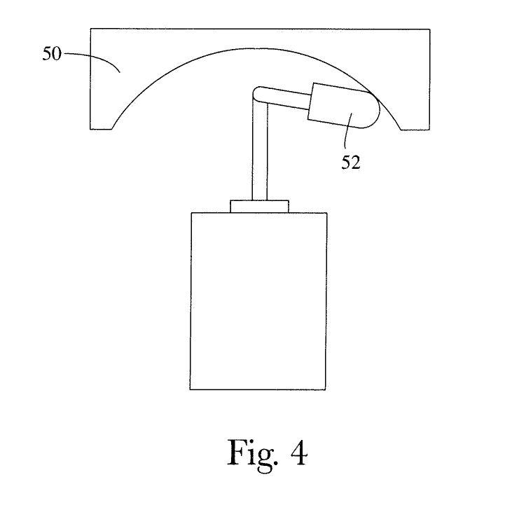

The amplitude adjustment through movement of a restrictor towards a movable mass can alternatively be done with physical contact between the two components. An example of this type of vibration amplitude adjustment is shown in FIG. 4, wherein a displacement restrictor 50 is employed to contact a rotating mass 52 to control the extent of the mass's radial displacement.

In some embodiments of the present invention, the vibration amplitude is adjustable while vibration frequency is held constant. In other embodiments, both amplitude and frequency are adjustable. For example, the amplitude can be adjusted through the features described above, while the frequency can be adjusted by altering the voltage input to the motor.

Although the discussion and figures have focused primarily on vibrating razors, the devices of the present invention can be designed for other personal care regimens besides shaving hair. A representative, non-limiting, list of vibrating devices contemplated by the present invention includes toothbrushes, flossing devices, hair care devices, skin care devices (e.g., skin rejuvenation products and non-cutting hair removal devices), pet care devices, and cosmetic devices. Accordingly, a different head configuration would likely be employed rather than a blade cartridge as is shown with the device in FIG. 1.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm. ”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1) A vibrating personal care device comprising:
(a) a head; and
(b) a handle extending from the head, the handle comprising:
i) a motor comprising a rotatable shaft;
ii) a mass affixed to the shaft, the mass being displaceable in a radially outward direction relative to the shaft in the presence of centrifugal force arising when the shaft is rotated; and
iii) A displacement restrictor movable relative to the mass in order to adjust and/or control the amount of radial displacement of the mass.

2) The device of claim 1, wherein each of the mass and the displacement restrictor comprises a magnet that is arranged so that movement of the displacement restrictor towards the mass causes the mass to repel in an opposite direction.

3) The device of claim 1, wherein the displacement restrictor physically contacts the mass to adjust and/or control the amount of displacement of the mass.

4) The device of claim 1, wherein the handle further comprises an actuator connectively associated with the displacement restrictor.

5) The device of claim 4, wherein the actuator comprises two or more distinct positions.

6) The device of claim 4, wherein the actuator is designed to be discretely movable between multiple, prearranged positions.

7) The device of claim 4, wherein the actuator is designed to be continuously movable between two extreme positions.

8) The device of claim 4, wherein the actuator and displacement restrictor utilize rack and pinion elements to facilitate movement thereof.

9) The device of claim 4, wherein the device is selected from the group consisting of a razor and a toothbrush.

10) A vibrating personal care device comprising:
(a) a head; and
(b) a handle extending from the head, the handle includes one or more interior compartments comprising:
i) a motor comprising a rotatable shaft;
ii) a battery to power the motor;
iii) a bob-weight affixed to the rotatable shaft, at least a portion of the bob-weight being constructed from material that can be acted upon by a magnetic field; and
iv) a magnet movable relative to the bob-weight to effect radial displacement of the bob-weight.

11) The device of claim 10, wherein the handle comprises an actuator accessible from an exterior of the handle, the actuator being capable of altering the position of the magnet.

12) The device of claim 11, wherein the actuator is also used to turn the motor on and off.

13) The device of claim 11, wherein the handle comprises a second actuator that is configured to turn the motor on and off through connection with the battery.

14) A vibrating personal care device comprising:
(a) a head;
(b) a handle extending from the head, the handle comprising:
i) a vibration-inducing system; and
ii) a vibration amplitude adjuster comprising a magnet that is movable relative to vibration-inducing system, wherein the magnet is capable of altering the position of at least one component of the vibration-inducing system so that the vibration amplitude changes.

15) The device of claim 13, wherein the magnet does not physically contact the vibration-inducing system to alter the position of the at least one component of the vibration-inducing system.

16) A method of adjusting and/or controlling vibration amplitude associated with a vibrating personal care device, comprising the steps of:
(a) providing a personal care device comprising a motor, a rotatable motor shaft, and a mass affixed to the shaft, wherein the mass is radially movable relative to the shaft between a first position when the shaft is not rotating to a second position when the shaft is rotating;
(b) restricting the location of the mass to a third position that is situated between the first position and the second position, thereby adjusting and/or controlling the amplitude of the vibrating device.

17) The method of claim 15, wherein step (b) is accomplished without physically contacting the mass.

18) The method of claim 16, wherein step (b) comprises the use of magnetic forces.

19) The method of claim 15, wherein the personal care device further comprises a movable magnet and wherein step (b) is accomplished by moving the magnet towards the mass.

20) The method of claim 15, wherein step (b) is accomplished by physically contacting the mass.
